(19) United States
(12) Patent Application Publication
(10) Pub. No.: US 2007/0007257 A1
(43) Pub. Date: Jan. 11, 2007

(54) Microwave plasma burner

(76) Inventors: Han Sup Uhm, Potomac, MD (US); Yong C. Hong, Inchon (KR); Won Ju Yi, Portland, OR (US)

Correspondence Address: Han Sup Uhm, 11613 Swains Lock Terrace, Potomac, MD, 20854, US

(21) Appl. No.: 11/172,968

(22) Filed: Jul. 5, 2005

(51) Int. Cl. B23K 9/00; B23K 9/02

(52) U.S. Cl. 219/121.48

(57) ABSTRACT

The present invention relates to an apparatus for generating flames and more particularly to the microwave plasma burner for generation of high-temperature plasma flame by injecting gaseous, liquid or solid-powder hydrocarbon-fuels into plasma generated by microwaves. The invention provides a compact and portable apparatus for generating plasma flame. The apparatus includes a magnetron, an electrical power supplier, a waveguide system, a microwave power monitering system, stub tuners, a discharge tube, a gas supply system, a plasma ignitor and a fuel supply system. The method and apparatus is described for generation of a large volume of high-temperature plasma by injecting gaseous, liquid or solid-powder hydrocarbon-fuels into the microwave plasma torch to decompose the hydrogen and carbon containing fuels, and to mix the resultant gaseous hydrogen and carbon compounds with air or oxygen gas, instantaneously generating a large volume of high-temperature flames.

### REFERENCE CITED

U.S. Patent Documents

| | | |
|---|---|---|
| 5,505,909 | 04/1996 | Dummersdorf et al |
| 5,830,328 | 11/1998 | Uhm |
| 6,620,394 B2 | 09/2003 | Uhm et al |
| 6,620,439 B2 | 10/2004 | Uhm et al |

### FIELD OF THE INVENTION

The present invention relates generally to the apparatus for generating flames, and particularly to the microwave plasma burner for generating a large volume of high-temperature plasma flames by injecting gaseous, liquid or solid-powder hydrocarbon-fuels into an atmospheric microwave plasma torch and by near perfect combustion of the fuels with air or oxygen gas through the high-temperature plasma torch.

### BACKGROUND OF THE INVENTION

The plasma torch in general is a device of arc plasma column generated between two electrodes. There are several kind of plasma torch including DC arc torch, induction torch and high-frequency capacitive torch. The DC arc torch is operated by the DC electric field between two electrodes, which must be replaced often due to their limited lifetime. The DC arc torch is also operated at a high arc current in the range of 50-10,000 A, which requires an expensive high electrical-power supplier. The induction torch and high-frequency capacitive torch are inefficient devices with typical thermal efficiency in the range of 40-50%. These conventional torches have a small volume of plasma, have high operational cost and require many expensive additional systems for operation.

In order to overcome difficulties of the conventional torches, a microwave plasma torch was proposed in U.S. Pat. No. 6,620,394 B2 issued to Uhm et. al., present inventors, on Sep. 16, 2003. The microwave plasma torch provides high density and high temperature plasmas in inexpensive ways, but the plasma volume and temperature of the microwave plasma torch decrease drastically outside the discharge tube, thereby limiting its capability of bulk treatment of waste. In this context, the purpose of the present invention is providing an apparatus for generating an enlarged plasma flames by injecting gaseous, liquid or solid-powder hydrocarbon-fuels into the microwave plasma torch.

### SUMMARY OF THE INVENTION

In order to generate a high-temperature large-volume plasma flames, the present invention includes a magnetron that generates microwaves;

a power supply system that provides an electrical power to the magnetron;

a microwave circulator that forwards the microwaves from the magnetron to a discharge tube and absorbs the reflected microwaves;

a directional monitoring system that monitors forward and backward microwave powers;

stub tuners that control the forward and backward microwave power;

a tapered waveguide system that delivers effectively the microwave power to the discharge tube;

a discharge tube wherein an oncoming microwave power is converted into a plasma column in a swirl gas injected from outside;

a gas supplier that provides the swirl gas to the discharge tube;

an ignitor that provides initial electrons to ignite plasma inside the discharge tube; and

a fuel supply system that injects hydrocarbon fuels into the plasma in the discharge tube and maintains the plasma flames in the flame exit.

The purpose of this invention is to modify the microwave plasma torch design such that the improved apparatus produces enlarged size plasma better suited for such industrial applications as burning toxic gases, purifying contaminated gases and liquids. The key features of this invention is directed to adding fuel injective nozzles to a microwave plasma torch whereby enlarging size of the plasma.

It is therefore an important object of the present invention to generate a large-volume of plasma flames with high temperature from hydrocarbon fuel and swirl gas so that this plasma flame serves as a high temperature source in waste incineration facilities where hazardous materials like dioxins may not be formed because of controlled incineration temperature due to the high temperature source of the present invention.

Other object of the present invention is generation of a high-temperature large-volume plasma flame for elimination of volatile organic compounds (VOCs) in air, elimination of dioxins from incinerators, elimination of hydrogen sulfide from factories and elimination of ammonia compounds from waste of livestock farms.

Another object of the present invention is generation of a high-temperature large-volume plasma flame for quick elimination of poisonous gas in air sprayed by terrorists, thereby deterring terror actions and protecting the public against any terrorist attack.

Additional objects, and advantages and novel features of the invention will be explained in the description which follows, and in part will be apparent from the description, and will be learned by practice of the invention. The objectives and other advantages of the invention will be realized and obtained by the process and apparatus, particularly pointed out in the written description and claims hereof, as well as the appended drawings.

### BRIEF DESCRIPTION OF DRAWING FIGURES

A more complete appreciation of the invention and many of its attendant advantages will be aided by reference to the following detailed description in connection with the accompanying drawings:

FIG. 1 is a block diagram illustrating the apparatus related to the microwave plasma burner of the present invention:

FIG. 2 is a side cross-sectional view of a microwave plasma burner in one of desirable examples of the present invention;

FIG. 3 is a side cross-sectional view of multiple-nozzle fuel-supply system;

FIG. 4 is a frontal projection view of two-nozzle fuel-supply system;

FIG. 5 is a side cross-sectional view of one-nozzle fuel-supply system with additional gas supply tube;

FIG. 6 is a side cross-sectional view of two-nozzle fuel-supply system with additional gas supply tube;

FIG. 7 is a frontal projection view of two-nozzle fuel-supply system with additional gas supply tube;

FIG. 8 is a side cross-sectional view of one-nozzle fuel-supply system with different angle of nozzle direction;

FIG. 9 is a side cross-sectional view of one-nozzle fuel-supply system with additional gas supply tube and with different angle of nozzle direction;

FIG. 10 is a side cross-sectional view of an application example of the microwave plasma burner;

### DETAILED DESCRIPTION

The present invention is about an apparatus for generation of high temperature flame, and particularly to the microwave plasma burner for generating a large volume of high-temperature plasma flame by injecting gaseous, liquid or solid-powder hydrocarbon-fuels into an atmospheric microwave plasma torch. The present invention provides a near perfect combustion of a hydrocarbon fuels with air or oxygen gas through the high-temperature plasma torch.

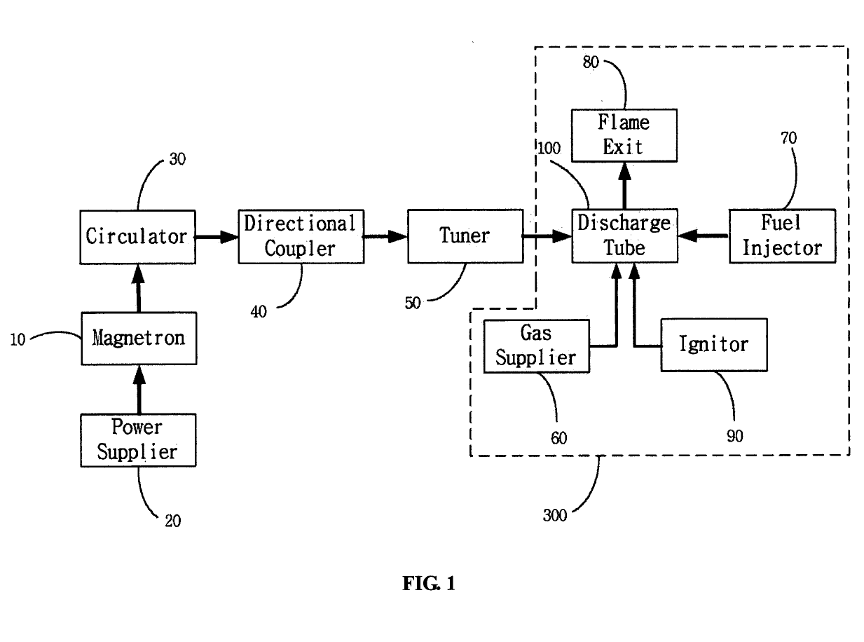

Referring now to the drawing in details, FIG. 1 is diagram of the microwave plasma burner system. The basic portion of the present invention is the discharge tube 100 and other adjacent devices 300, where air or oxygen gas enters the discharge tube 100 made of dielectric materials like quartz or alumina through the gas supplier 60, making a swirl gas inside the discharge tube 100. The power supplier 20 made of AC transformers or DC power suppliers provides the electrical power into the magnetron 10, which generates microwaves. The circulator 30 sends the microwaves from the magnetron 10 into the directional coupler 40 and protects the magnetron 20 from reflected waves caused by impedance mismatching, which can be corrected by the 3-stub tuner 50, reducing the reflected wave intensity less than 1%. The reflected wave intensity is less than 10% of the incoming wave intensity even without tuner adjustment, once the plasma torch is ignited.

The electrode tips of the ignitor 90 inside the discharge tube 100 provide initiation electrons of the plasma column in the discharge tube 100. The swirl gas from the gas supplier 60 inside the discharge tube 100 stabilizes plasma column and protects inner wall of the discharge tube 100 from plasma heat. The plasma column length depends on the amount of swirl gas. For example, the plasma column length is about 20-30 cm for 1 kW microwave power with 2.45 GHz, for a quartz discharge tube with 27 mm inner diameter and for 20 liters per minute (lpm) of air swirl gas. The plasma column length reduces to 10 cm if the swirl gas increases from 20 to 80 lpm. The hydrocarbon fuel from the fuel injector system 70 enters the discharge tube 100 sideways and the plasma flame generated from fuel with air or oxygen exits through the flame exit 80. For example, the liquid hydrocarbon fuel evaporates instantaneously by the plasma column with its center temperature of 5000-6000 degree Celsius and burns immediately with air. The aforementioned hydrocarbon fuel is methane, ethane, propane, butane in gaseous state, gasoline, diesel, kerosene, bunker oil, waste oil in liquid state and coal powders in solid state, etc.

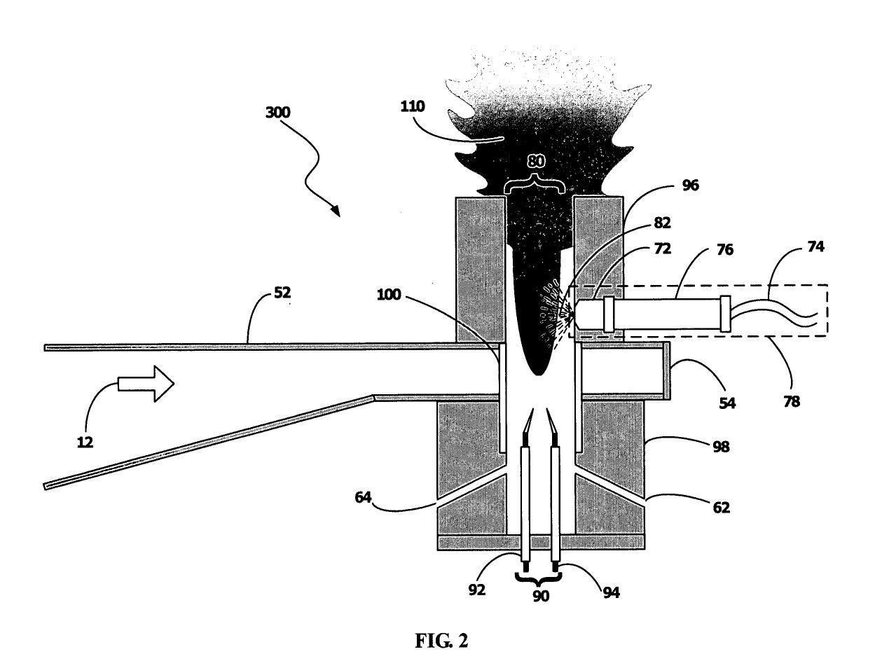

FIG. 2 is a side cross-sectional view of the apparatus designated by the dashed box 300 in FIG. 1 and represents a drawing of the microwave plasma torch and fuel injector. The microwaves 12 from the 3-stub tuner 50 in FIG. 1 passes through the tapered waveguide 52 and enter the discharge tube 100 installed at the location a quarter wavelength away from the end 54 of the waveguide 52. Height of the tapered waveguide 52 attached to a standard rectangular waveguide (86 mm width and 43 mm height) is gradually reduced to induce the maximum energy density at the discharge tube 100 location. The swirl gas suppliers 62 and 64 in FIG. 2 are attached to the upstream housing 98 made of metal such as stainless steel and is configured to form a vortex flow inside the discharge tube 100. The swirl gas supplier can have one gas injector or multiple gas injectors to ensure a uniform vortex flow inside the discharge tube 100. The swirl gas can be air, oxygen or a mixture of air and oxygen. The ignitor 90 provides initiation electrons of the plasma column from the microwaves and the swirl gas, and its electrode tip must be located inside the discharge tube 100. The ignitor 90 consisted of the tungsten electrode 94 and dielectric tube is wrapped by a dielectric material such as ceramic, in order to prevent arcing between the ignitor 90 and the upstream housing 98. The downstream housing 96 made of metal has the same inner size as the discharge tube and is installed on the tapered waveguide to sustain a steady vortex flow of the swirl gas. The fuel injector 78 is installed in the downstream housing 96 to provide fuel for plasma flame. The fuel injector 78 consists of nozzle head 72, nozzle body 76 and fuel supply tube 74. The fuel injector 78 is located at a certain distance from the tapered waveguide 52, and there can be one fuel injector or multiple fuel injectors. The hydrocarbon fuel 82 injected into plasma mixes with the swirl gas (air or oxygen) and extends plasma flame 110 into the flame exit 80.

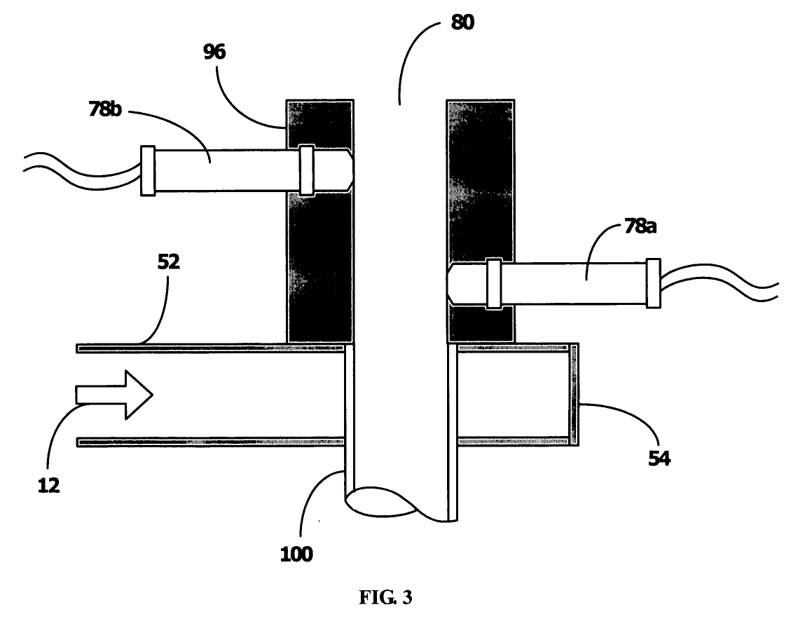

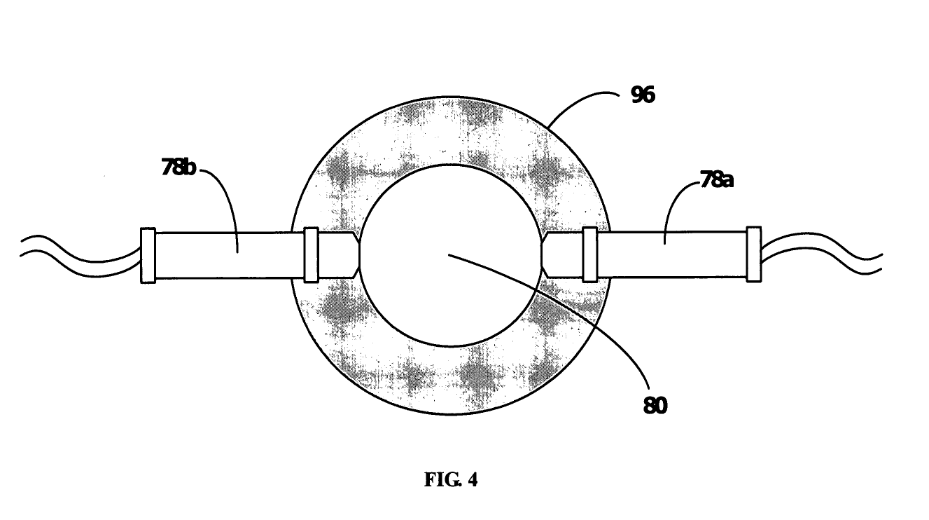

FIG. 3 is a side cross-sectional view of the double fuel injectors installed at the downstream housing 96 with different distances relative to the tapered waveguide 52. In order to have a large and extended plasma flame 110, multiple fuel injectors 78a and 78b are installed at the downstream housing 96 in FIG. 3. Each fuel injector in the multiple fuel injector system injects fuel into different part of the plasma column, extending the burner size and enlarging the plasma-flame volume. FIG. 4 is a frontal projection view of multiple fuel injector system. The fuel injectors 78a and 78b installed in the downstream housing 96 in FIG. 4 are arranged to have 180 degree angular separation between them. There may have more fuel injectors with an equal angular separation between them and located at different distances relative to the tapered waveguide 52, if needed for further enlargement of the plasma flame.

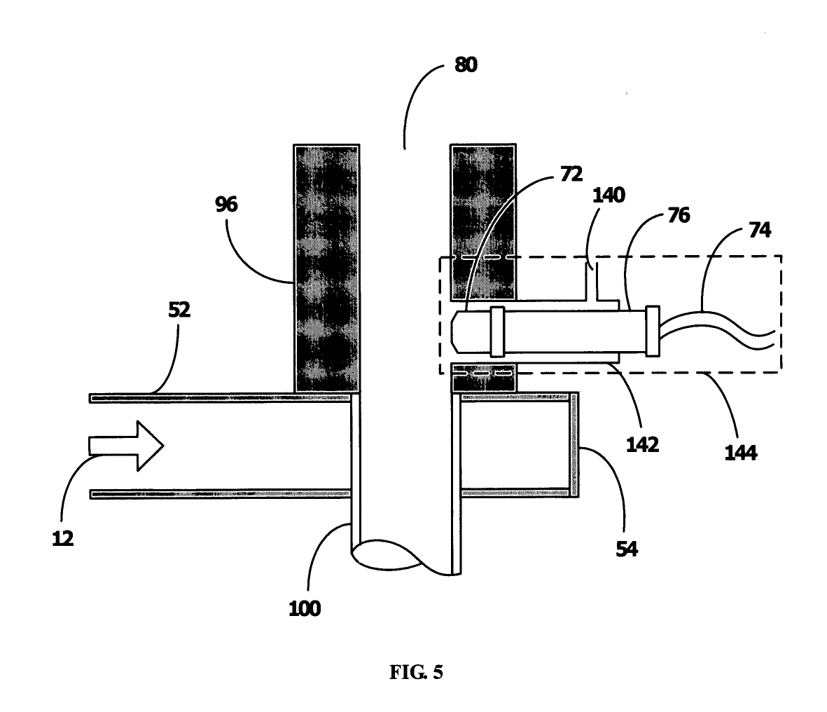

FIG. 5 is a side cross-sectional view of the fuel injector with additional gas supplier. The fuel injector system 144 with additional oxidation-gas supply consists of nozzle head 72, nozzle body 76, fuel supply tube 74, additional gas-supply input 140 and additional gas injector 142. The additional oxygen gas can be supplied through the gas-supply input 140, supplying oxygen gas and fuel deep into the plasma column.

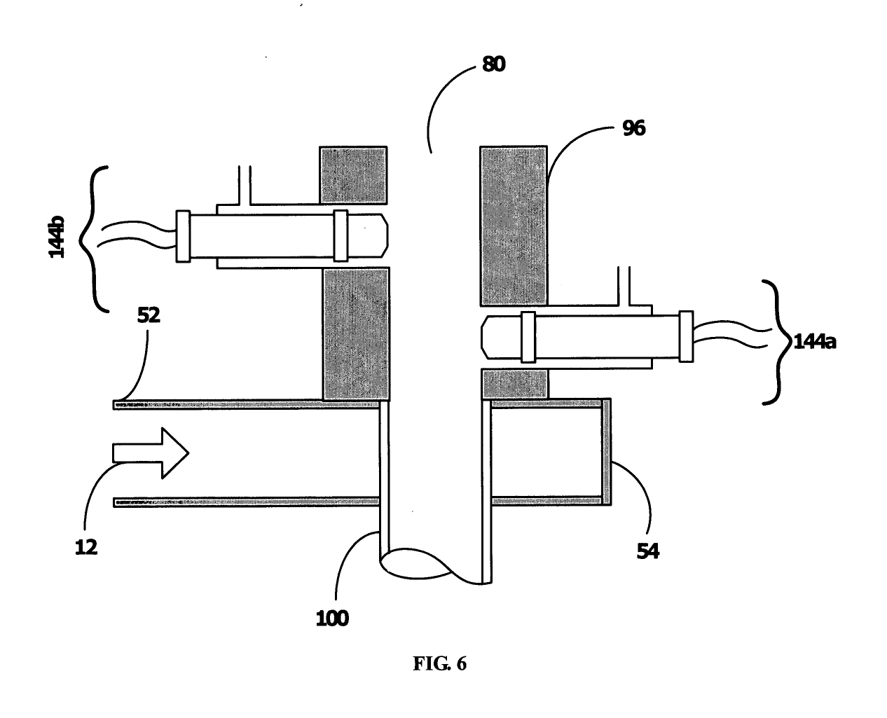

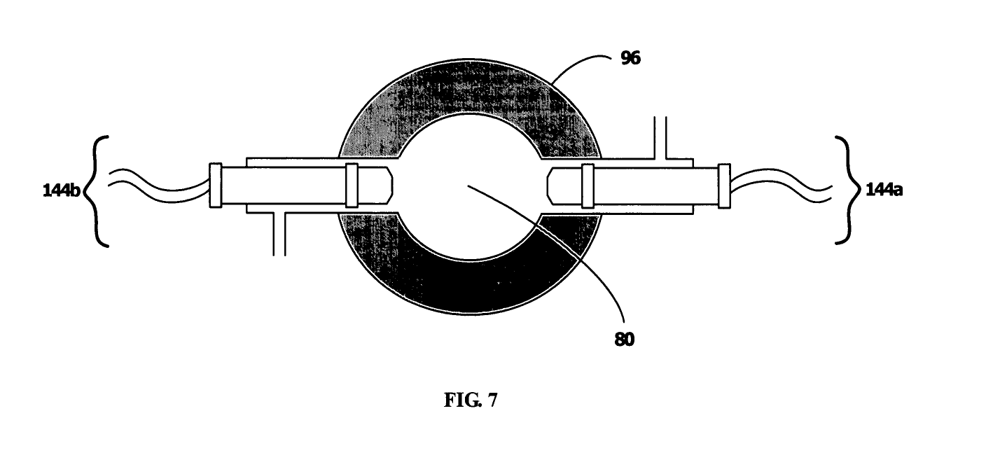

FIG. 6 is a side cross-sectional view of the double fuel injectors with additional gas supplier, which are installed at the downstream housing 96 with different distances relative to the tapered waveguide 52. In order to have a large and extended plasma flame 110, multiple fuel injectors 144a and 144b are installed at the downstream housing 96. Each fuel injector in the multiple fuel injector system with additional oxygen gas injects fuel and additional oxygen gas into different part of the plasma column, extending the burner size and enlarging the plasma-flame volume. FIG. 7 is a frontal projection view of multiple fuel injector system with additional oxygen supplier. The fuel injectors 144a and 144b with additional oxygen supplier installed in the downstream housing in FIG. 6 are arranged to have 180 degree angular separation between them. There may have more fuel injectors with additional oxygen supplier, with an equal angular separation between them and located at different distances relative to the tapered waveguide 52, if needed for further enlargement of the plasma flame.

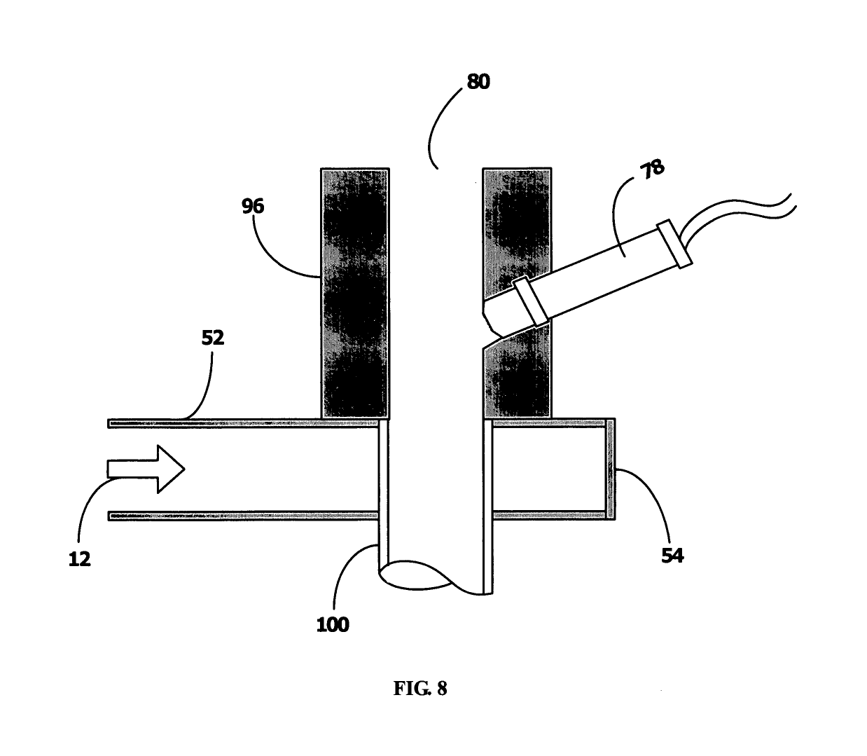

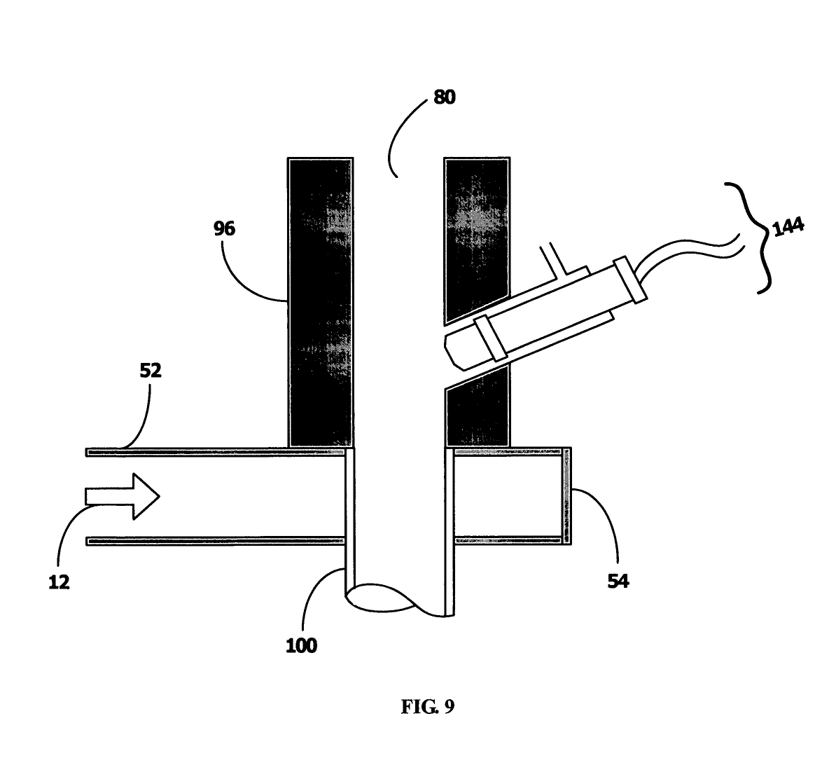

FIG. 8 is a side cross-sectional view of a fuel injector 78 which has a certain injection angle in the range of from 0 degree to 180 degree against the axial direction of the burner. Multiple injectors can be installed around the downstream housing 96 with an equal angular separation between them and located at different distances relative to the tapered waveguide 52, similar to FIG. 4, if needed for further enlargement of the plasma flame. FIG. 9 is a side cross-sectional view of the fuel injector 144 with additional oxygen supplier installed at the downstream housing 96. The fuel injector 144 has a certain injection angle in the range of 0 degree to 180 degree against the axial direction of the burner.

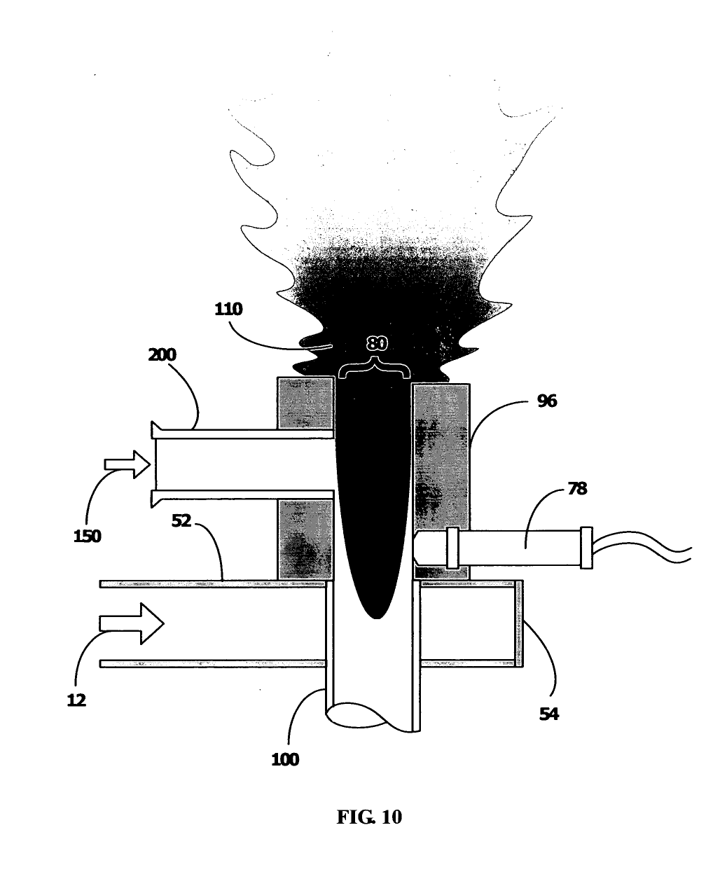

FIG. 10 is a side cross-sectional view of an application example of the microwave plasma burner shown in FIG. 2. A contaminated gas 150 enters the microwave plasma flame 110 through the untreated-gas supply tube 200 located further downstream from the fuel injector 78 and the contaminant materials in the contaminated gas 150 are dissociated by the high-temperature plasma flame 110. The contaminant materials are chemical and biological warfare agents, waste-gas from the cleaning process in semiconductor industries, volatile organic compounds, and bad smelling gases from factories.

### EXAMPLE

The microwaves 12 with 2.45 GHz and 1 kW power generated from the magnetron 10 enter the discharge tube 100 with its inner diameter of 27 mm. The air swirl gas of 50 liters per minute (lpm) from the gas supply 60 creates a vortex flow inside the discharge tube 100. Kerosene injected from the fuel injector system 78 in FIG. 2 into the discharge tube 100 is 1500 cc per hour. The length of the downstream housing 96 in FIG. 2 is about 10 cm. The plasma flame is shooting out through the flame exit 80 in FIG. 2. The plasma flame diameter and length from the flame exit 80 are about 10 cm and 40 cm, respectively. The flame temperature at the center of the flame exit measured by a thermo-coupler is about 1400 degree Celsius. 20 lpm oxygen gas is added to the swirl gas and it was observed that the plasma flame color changes from yellowish white to bluish white. The flame temperature at the flame exit with additional oxygen gas is measured to be 1700 degree Celsius.

Although this embodiment is the microwave plasma burner for the generation of high-temperature plasma flame by injecting gaseous, liquid or solid-powder hydrocarbon-fuels into plasma generated by microwaves, the invention is not limited to the use of the microwave plasma burner. Without departing from the spirit of the invention, numerous other rearrangements, modifications and variations of the present invention are possible in light of the foregoing teachings. It is therefore to be understood that within the scope of the appended claims, the invention may be practiced otherwise than as specifically described.

What is claimed is:

1. An apparatus of the microwave plasma burner for generating a large volume of high-temperature plasma flame, said apparatus comprising:
(a) a discharge tube equipped with a microwave radiation generator for forming a microwave plasma torch with an ignition device, a gas supplier for swirl gas and a tapered waveguide; and
(b) a fuel injector system that injects hydrocarbon fuels into the plasma in said discharge tube and maintains the plasma flames in the flame exit.

2. In the apparatus according to claim 1, wherein said discharge tube is located approximately ⅛ to ½ of wavelength away from the end of said waveguide, placed between the upstream and downstream housings, and is arranged to be perpendicular to the broad surface of said waveguide.

3. In the apparatus according to claim 1, wherein said gas supplier provides at least one swirl-gas passage between the internal space of said discharge tube and the outside of the upstream housing with its internal space in continuation to the internal space of said discharge tube.

4. In the apparatus according to claim 3, wherein said upstream housing under said discharge tube is made of such metals as stainless steel or is coated with metal alloys for isolation from microwave influence.

5. In the apparatus according to claim 3, wherein said swirl-gas passage is inclined toward downstream.

6. In the apparatus according to claim 1, wherein said fuel injector system with at least one fuel nozzle is attached to said downstream housing installed on top of said discharge tube and equipped with flame exit.

7. In the apparatus according to claim 6, wherein said downstream housing is made of a metal or is coated with metal alloys for isolation from microwave influence.

8. In the apparatus according to claim 6, wherein said fuel injector system consists of multiple fuel injectors installed at said downstream housing with different distances relative to said tapered waveguide and with an equal angular separation between said injectors.

9. In the apparatus according to claim 8, wherein said fuel injector also has additional gas suppliers.

10. A process for generating an enlarged high-temperature plasma flame by
(a) focusing microwaves at the center of a discharge tube and initiating a plasma torch inside said discharge tube; and
(b) injecting gaseous, liquid or solid-powder hydrocarbon-fuels into the plasma torch through fuel injectors and maintaining the plasma flames in the flame exit

11. In the process according to claim 10, wherein the said fuel injectors inject fuel at an angular direction relative to the burner axis.

12. In the process according to claim 10, wherein said hydrocarbon fuel is methane, ethane, propane, butane in gaseous state, gasoline, diesel, kerosene, bunker oil, waste oil in liquid state, coal powders, carbon powders in solid state, or a mixture of these fuels.

13. In the process according to claim 10, wherein said swirl gas is air, oxygen, nitrogen, argon or a mixture of these gases.

14. In the process according to claim 10, wherein the microwave frequency from a microwave radiation generator is in the range of 500 MHz-10 GHz.
